(19) United States
(12) Patent Application Publication
(10) Pub. No.: US 2024/0214512 A1
(43) Pub. Date: Jun. 27, 2024

(54) SYSTEMS AND METHODS FOR WIRELESS REAL-TIME MULTI-CHANNEL AUDIO AND VIDEO INTEGRATION

(71) Applicant: Mixhalo Corp., San Francisco, CA (US)

(72) Inventors: Ty Daniels, Austin, TX (US); Jeffrey Thomas Miller, San Diego, CA (US); Charles Edward Luckhardt, IV, San Francisco, CA (US); Vikram Singh, San Francisco, CA (US)

(21) Appl. No.: 18/594,036

(22) Filed: Mar. 4, 2024

Related U.S. Application Data
(63) Continuation-in-part of application No. 18/219,778, filed on Jul. 10, 2023.
(60) Provisional application No. 63/389,219, filed on Jul. 14, 2022.
(60) Provisional application No. 63/449,771, filed on Mar. 3, 2023.

(51) Int. Cl. H04N 5/265; G06F 3/16

(52) U.S. Cl. CPC H04N 5/265; G06F 3/162

(57) ABSTRACT

A method of wireless capture of real-time multi-channel audio and video using a mobile computing device and a wireless access point includes detecting a first musical instrument and a second musical instrument via a multi-channel audio interface wirelessly coupled to the instruments using a short-range communication protocol. The method also includes receiving a first live audio signal from the first musical instrument and a second live audio signal from the second musical instrument. The method also includes receiving a data representation of the first live audio signal and the second live audio signal via a wireless network. The method also includes processing the data representation of the first live audio signal and the second live audio signal into a live audio stream. The method also includes initiating a video capture and, concurrent with the video capture, producing a shareable video based on the captured video and the live audio stream.

### RELATED APPLICATION(S)

This application is a continuation-in-part of U.S. patent application Ser. No. 18/219,778, filed on Jul. 7, 2023, which claims priority to U.S. Provisional Patent Application No. 63/389,219, filed on Jul. 14, 2022, the entire disclosure of each of which is incorporated herein by reference. This application also claims priority to U.S. Provisional Patent Application No. 63/449,771, filed on Mar. 3, 2023, the entire disclosure of which is incorporated herein by reference.

### FIELD OF THE INVENTION

This invention relates generally to the field of real-time delivery of data, such as audio, over wireless networks. More specifically, the invention relates to systems and methods for integrating real-time multi-channel audio with user captured video.

### BACKGROUND

Modern actors and musicians often capture recordings of themselves and others while performing with the intention of sharing the recordings on social media platforms. Capturing these recordings requires several components, including a camera, an audio mixer that is hard-wired to microphones and/or musical instruments, and a mobile device capable of stitching together the video and audio feeds. However, having all these components hard-wired together may be limiting and costly, and may not guarantee the best audio and/or video quality.

Therefore, there is a need for systems and methods that allow for integration of multiple audio and video feeds using wireless technologies while maintaining audio and video quality.

### SUMMARY

The present invention includes systems and methods for wireless capture of real-time multi-channel audio and video using a mobile computing device and a wireless access point. For example, the present invention includes systems and methods for detecting one or more musical instruments via a multi-channel audio interface. The present invention includes systems and methods for receiving one or more live audio signals from the musical instruments via the multi-channel audio interface. The present invention includes systems and methods for receiving a data representation of the first live audio signal and the second live audio signal via a wireless network. The present invention includes systems and methods for processing the data representation of the first live audio signal and the second live audio signal into a live audio stream. The present invention includes systems and methods for initiating a video capture and, concurrent with the video capture, produce a shareable video based on the capture video and the live audio stream.

In one aspect, the invention includes a computerized method for wireless capture of real-time multi-channel audio and video using a mobile computing device and a wireless access point. The computerized method includes detecting a first musical instrument and a second musical instrument via a multi-channel audio interface, the first musical instrument and the second musical instrument being wirelessly coupled to the multi-channel audio interface using a short-range communication protocol. In some embodiments, the wireless access point is a Wi-Fi™ access point. In some embodiments, the multi-channel audio interface pairs with the first musical instrument and the second musical instrument prior to receiving the first live audio signal from the first musical instrument and receiving the second live audio signal from the second musical instrument. For example, in some embodiments, the wireless access point is configured to automatically detect the first musical instrument and the second musical instrument via the multi-channel audio interface.

The computerized method also includes receiving a first live audio signal from the first musical instrument and a second live audio signal from the second musical instrument via the multi-channel audio interface.

The computerized method also includes receiving a data representation of the first live audio signal and the second live audio signal by a mobile computing device via a wireless network. The computerized method also includes processing the data representation of the first live audio signal and the second live audio signal into a live audio stream by the mobile computing device.

The computerized method also includes initiating a video capture by the mobile computing device. The computerized method also includes, concurrent with the video capture, producing a shareable video based on the captured video and the live audio stream by the mobile computing device. In some embodiments, the mobile computing device is further configured to upload the produced shareable video to a social network.

In some embodiments, the video capture includes ambient audio captured by one or more microphones of the mobile computing device. For example, in some embodiments, the produced shareable video further includes the ambient audio from the video capture. In other embodiments, an audio mix including the live audio stream and the ambient audio is configurable by a user of the mobile computing device. In some embodiments, the video capture includes a first video feed from a rear-facing camera of the mobile computing device and a second video feed from a front-facing camera of the mobile computing device. For example, in some embodiments, the produced shareable video includes video from the first video feed and the second video feed. In some embodiments, the short-range communication protocol is Bluetooth.

In another aspect, the invention includes a system for wireless capture of real-time multi-channel audio and video using a mobile computing device and a wireless access point. The system includes a mobile computing device communicatively coupled to a wireless access point over a wireless network. The wireless access point is configured to detect a first musical instrument and a second musical instrument via a multi-channel audio interface, the first musical instrument and the second musical instrument being wirelessly coupled to the multi-channel audio interface using a short-range communication protocol. In some embodiments, the wireless access point is a Wi-Fi access point. In some embodiments, the multi-channel audio interface pairs with the first musical instrument and the second musical instrument prior to receiving the first live audio signal from the first musical instrument and receiving the second live audio signal from the second musical instrument. For example, in some embodiments, the wireless access point is configured to automatically detect the first musical instrument and the second musical instrument via the multi-channel audio interface.

The wireless access point is also configured to receive a first live audio signal from the first musical instrument and a second live audio signal from the second musical instrument via the multi-channel audio interface.

The mobile computing device is also configured to receive a data representation of the first live audio signal and the second live audio signal via the wireless network. The mobile computing device is also configured to process the data representation of the first live audio signal and the second live audio signal into a live audio stream. The mobile computing device is also configured to initiate a video capture. The mobile computing device is also configured to, concurrent with the video capture, produce a shareable video based on the captured video and the live audio stream. In some embodiments, the mobile computing device is further configured to upload the produced shareable video to a social network.

In some embodiments, the video capture includes ambient audio captured by one or more microphones of the mobile computing device. For example, in some embodiments, the produced shareable video further includes the ambient audio from the video capture. In other embodiments, an audio mix including the live audio stream and the ambient audio is configurable by a user of the mobile computing device. In some embodiments, the video capture includes a first video feed from a rear-facing camera of the mobile computing device and a second video feed from a front-facing camera of the mobile computing device. For example, in some embodiments, the produced shareable video includes video from the first video feed and the second video feed. In some embodiments, the short-range communication protocol is Bluetooth.

These and other aspects of the invention will be more readily understood from the following descriptions of the invention, when taken in conjunction with the accompanying drawings and claims.

### BRIEF DESCRIPTION OF THE DRAWINGS

FIG. 1 is a schematic diagram of a system architecture for wireless capture of real-time audio and video at a live event using a mobile computing device, according to an illustrative embodiment of the invention.

FIG. 2 is a schematic diagram of a system architecture for wireless capture of real-time multi-channel audio and video using a mobile computing device, according to an illustrative embodiment of the invention.

FIG. 3 is a schematic flow diagram illustrating wireless capture of real-time multi-channel audio and video using the system architecture of FIG. 2, according to an illustrative embodiment of the invention.

### DETAILED DESCRIPTION

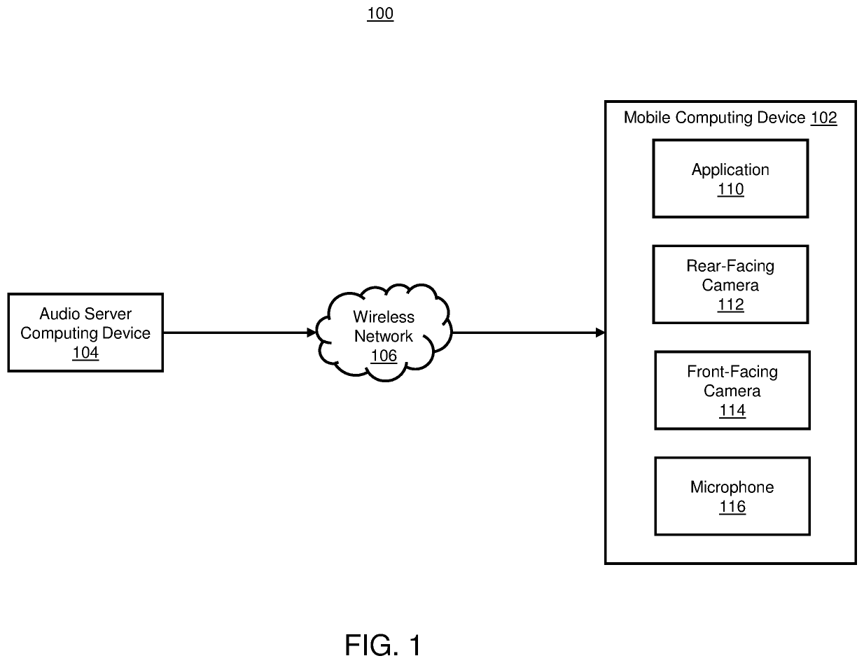

FIG. 1 is a schematic diagram of a system architecture 100 for wireless capture of real-time audio and video at a live event using a mobile computing device, according to an illustrative embodiment of the invention. System 100 includes a mobile computing device 102 communicatively coupled to an audio server computing device 104 over a wireless network 106. Mobile computing device 102 includes an application 110, a rear-facing camera 112, a front-facing camera 114, and a microphone 116. In some embodiments, the audio server computing device 104 is communicatively coupled to an audio interface (not shown).

Exemplary mobile computing devices 102 include, but are not limited to, tablets and smartphones, such as Apple® iPhone®, iPad® and other iOS®-based devices, and Samsung® Galaxy®, Galaxy Tab™ and other Android™-based devices. It should be appreciated that other types of computing devices capable of connecting to and/or interacting with the components of system 100 can be used without departing from the scope of invention. Although FIG. 1 depicts a single mobile computing device 102, it should be appreciated that system 100 can include a plurality of client computing devices.

Mobile computing device 102 is configured to receive instructions from application 110 in order to wirelessly capture real-time audio and video at a live event. For example, mobile computing device 102 is configured to receive a data representation of a live audio signal corresponding to the live event via wireless network 106. In some embodiments, the mobile computing device 102 receives the data representation of the live audio signal from the audio server computing device 104, which in turn is coupled to an audio source at the live event (e.g., a soundboard that is capturing the live audio). Mobile computing device 102 is also configured to process the data representation of the live audio signal into a live audio stream. Mobile computing device 102 is also configured to initiate a video capture corresponding to the live event. In some embodiments, a user attending the live event initiates the video capture using application 110. An exemplary application 110 can be an app downloaded to and installed on the mobile computing device 102 via, e.g., the Apple® App Store or the Google® Play Store. The user can launch application 110 on the mobile computing device 102 and interact with one or more user interface elements displayed by the application 110 on a screen of the mobile computing device 102 to initiate the video capture.

Mobile computing device 102 is also configured to, concurrent with the video capture, produce a shareable video corresponding to the live event based on the captured video and the live audio stream. Generally, the produced shareable video comprises high quality audio from the live audio stream alongside video captured by and from the perspective of a user attending the live event. In some embodiments, the mobile computing device 102 is configured to produce the shareable video concurrent with the video capture. For example, during video capture, the mobile computing device 102 can integrate the live audio stream corresponding to the live event with the captured video corresponding to the live event to produce the shareable video.

In some embodiments, the mobile computing device 102 is further configured to upload the produced shareable video to a social network. For example, the mobile computing device 102 can be configured to transmit the produced shareable video via the wireless network 106 to a server computing device associated with the social network (not shown). Exemplary social networks include, but are not limited to, Facebook®, Instagram®, TikTok®, and YouTube®. In some embodiments, the mobile computing device 102 is configured to receive the data representation of the live audio signal corresponding to the live event from the audio server computing device 104 via the wireless network 106.

In some embodiments, video capture includes ambient audio captured by one or more microphones 116 of the mobile computing device. As an example, the ambient audio can comprise audio that corresponds to the live audio stream (i.e., audio relating to one or more performers at the live event, such as musicians on stage), but is being emitted by loudspeakers and captured by microphones 116 of the mobile computing device 102. The ambient audio captured by microphones 116 can also include audio from various sources in proximity to the mobile computing device 102, such as audience members, announcers, and other sources in the surrounding environment. In some embodiments, the produced shareable video includes the ambient audio from the video capture. In some embodiments, an audio mix including the live audio stream and the ambient audio is configurable by a user of the mobile computing device 102 via application 110. In some embodiments, each of the live audio stream and the ambient audio is received by application 110 as a separate channel, and a user of the mobile computing device 102 can adjust a relative volume of each channel to produce an audio mix that comprises both the live audio stream and the ambient audio according to the relative volume settings. For example, application 110 can display a slider or knob to the user, with an indicator set to a middle position (indicating an equally balanced mix between the live audio stream and the ambient audio). When the user adjusts the indicator in one direction (e.g., left), the application 110 can increase the relative volume of the live audio stream and reduce the relative volume of the ambient audio. Similarly, when the user adjust the indicator in the other direction (e.g., right), application 110 can increase the relative volume of the ambient audio and decrease the relative volume of the live audio stream.

In some embodiments, the video capture includes a first video feed from a rear-facing camera 112 of the mobile computing device 102 and a second video feed from a front-facing camera 114 of the mobile computing device 102. For example, in some embodiments, the produced shareable video includes video from the first video feed and the second video feed. In one example, the user can hold the mobile computing device 102 such that the field of view of the rear-facing camera 112 is pointing toward the live event (e.g., at the performers on stage) while the field of view of the front-facing camera 114 is pointing toward the user (e.g., to capture the user's reaction to the performance). In some embodiments, each of these video feeds is captured by the mobile computing device 102 as a separate video file or stream. In some embodiments, the mobile computing device 102 combines the first video feed and the second video feed into a combined video capture—for example, the second video feed from the front-facing camera can be overlaid in a portion (e.g., a corner) of the first video feed from the rear-facing camera so that each of the video feeds can be seen concurrently.

In some configurations, system 100 includes a headphone (not shown) communicatively coupled to the mobile computing device 102. The headphone may include a microphone (in addition to microphone 116). For example, in some embodiments, the mobile computing device 102 is configured to capture ambient audio using the headphone's microphone. In some embodiments, the mobile computing device 102 is configured to capture ambient audio using the headphone's microphone in response to the user initiating a camera flip using the application 110.

Audio server 104 is a computing device comprising specialized hardware and/or software modules that execute on one or more processors and interact with memory modules of the audio server computing device, to receive data from other components of the system 100, transmit data to other components of the system 100, and perform functions relating to wireless capture of real-time audio and video at a live event using a mobile computing device as described herein. In some embodiments, audio server computing device 104 is configured to receive a live audio signal from an audio source at the live event (e.g., a soundboard that is capturing the live audio) and transmit a data representation of the live audio signal via network 106 to one or more mobile computing devices 102.

In some embodiments, audio server computing device 104 can pre-process the live audio signal when generating the data representation of the live audio signal prior to transmission to mobile computing devices. For example, the audio server computing device 104 can generate one or more data packets corresponding to the live audio signal. In some embodiments, creating a data representation of the live audio signal includes using one of the following compression codecs: AAC, HE-AAC MP3, MPE VBR, Apple Lossless, IMA4, IMA ADPCM, or Opus.

Wireless network 106 is configured to communicate electronically with network hardware of the audio server computing device 104 and to transmit the data representation of the live audio signal to the mobile computing device 102. In some embodiments, the network 104 can support one or more routing schemes, e.g., unicast, multicast and/or broadcast.

Additional detail regarding illustrative technical features of the methods and systems described herein are found in U.S. Pat. No. 11,461,070, titled “Systems and Methods for Providing Real-Time Audio and Data” and issued Oct. 24, 2022; U.S. Pat. No. 11,625,213, titled “Systems and Methods for Providing Real-Time Audio and Data,” and issued Apr. 11, 2023; U.S. patent application Ser. No. 18/219,778, titled “Systems and Methods for Wireless Real-Time Audio and Video Capture at a Live Event” and published Jan. 18, 2024; and U.S. patent application Publication Ser. No. 18/219,792, titled “Systems and Methods for Wireless Real-Time Audio and Video Capture at a Live Event” and published Jan. 18, 2024, the entirety of each of which is incorporated herein by reference.

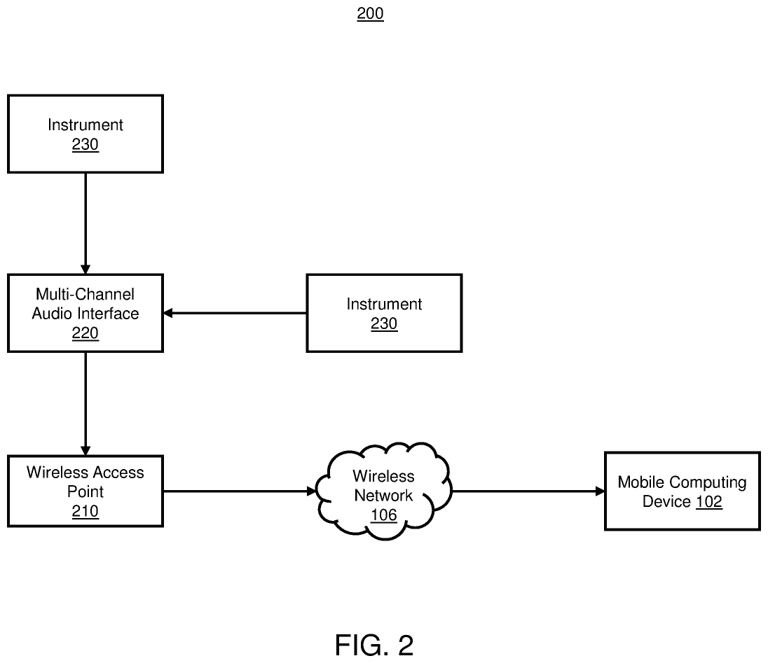

FIG. 2 is a schematic diagram of a system architecture 200 for wireless capture of real-time multi-channel audio and video using a mobile computing device 102, according to an illustrative embodiment of the invention. System 200 includes a wireless access point 210 communicatively coupled to a mobile computing device 102 over a wireless network 106. In some embodiments, the wireless access point 210 is a Wi-Fi™ access point. The wireless access point 210 is communicatively coupled to one or more instruments 230 via a multi-channel audio interface 220. The multi-channel audio interface 220 may be integrated with the wireless access point 210 or may be separate from and in electronic communication with the wireless access point 210.

Instruments 230 are wirelessly coupled to the multi-channel audio interface 220 using a short-range communication protocol. In some embodiments, the one or more instruments 230 are Bluetooth®-enabled. For example, in some embodiments, the multi-channel audio interface 220 is a Bluetooth®-enabled multi-channel audio interface configured to receive one or more audio signals from the one-or more instruments 230. In some embodiments, the wireless access point 210 is configured to automatically detect Bluetooth®-enabled instruments 230 (e.g., that are in proximity to the wireless access point 210) via an integrated or standalone Bluetooth®-enabled multi-channel audio interface 220 that is coupled to the wireless access point 210. In some embodiments, the wireless access point 210 is configured with discover mode, so nearby Bluetooth®-enabled instruments 230 are configured to sync and stream audio. In some embodiments, the multi-channel audio interface 220 is configured to automatically detect nearby musical instruments 230 that are enabled to communicate via the short-range communication protocol. Upon detecting the nearby instruments, the multi-channel audio interface 220 initiates a pairing process whereby the interface 220 establishes a wireless connection with the instruments 230 and registers certain device information for the instruments 230, so that the connection between the instruments 230 and the interface 220 can be automatically established in the future without repeating the pairing process.

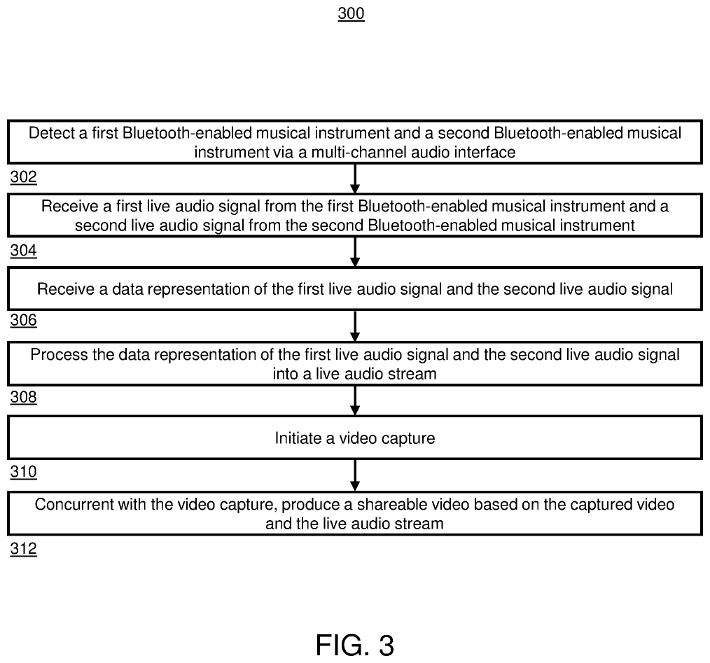

FIG. 3 is a schematic flow diagram of a process 300 illustrating wireless capture of real-time multi-channel audio and video using a mobile computing device 102 and a wireless access point 210, according to an illustrative embodiment of the invention. Process 300 begins by detecting a first Bluetooth®-enabled musical instrument 230 and a second Bluetooth®-enabled musical instrument 230 by a wireless access point 210 via a multi-channel audio interface 220 at step 302. In some embodiments, the wireless access point 210 is a Wi-Fi™ access point. In some embodiments, the multi-channel audio interface 220 is a Bluetooth®-enabled multi-channel audio interface. For example, in some embodiments, the wireless access point 210 is configured to automatically detect the first Bluetooth®-enabled musical instrument 230 and the second Bluetooth®-enabled musical instrument 230 via the Bluetooth®-enabled multi-channel audio interface 220.

Process 300 continues by receiving a first live audio signal from the first Bluetooth®-enabled musical instrument 230 and a second live audio signal from the second Bluetooth®-enabled musical instrument 230 by the wireless access point 210 via the multi-channel audio interface 220 at step 304. Process 300 continues by receiving a data representation of the first live audio signal and the second live audio signal by a mobile computing device 102 via a wireless network 106 at step 306. Process 300 continues by processing the data representation of the first live audio signal and the second live audio signal into a live audio stream by the mobile computing device 102 at step 308.

Process 300 continues by initiating a video capture by the mobile computing device 102 at step 310. Process 300 finished by, concurrent with the video capture, producing a shareable video based on the captured video and the live audio stream by the mobile computing device 102 at step 312. In some embodiments, the mobile computing device 102 is further configured to upload the produced shareable video to a social network.

In some embodiments, the video capture includes ambient audio captured by one or more microphones 116 of the mobile computing device 102. For example, in some embodiments, the produced shareable video further includes the ambient audio from the video capture. In other embodiments, an audio mix including the live audio stream and the ambient audio is configurable by a user of the mobile computing device 102. In some embodiments, the video capture includes a first video feed from a rear-facing camera 112 of the mobile computing device 102 and a second video feed from a front-facing camera 114 of the mobile computing device 102. For example, in some embodiments, the produced shareable video includes video from the first video feed and the second video feed.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application, and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting the subject matter described herein.

What is claimed is:

1. A computerized method for wireless capture of real-time multi-channel audio and video using a mobile computing device and a wireless access point, the method comprising:
detecting, by a wireless access point, a first musical instrument and a second musical instrument via a multi-channel audio interface, the first musical instrument and the second musical instrument wirelessly coupled to the multi-channel audio interface using a short-range communication protocol;
receiving, by the wireless access point, a first live audio signal from the first musical instrument and a second live audio signal from the second musical instrument via the multi-channel audio interface;
receiving, by a mobile computing device, a data representation of the first live audio signal and the second live audio signal via a wireless network;
processing, by the mobile computing device, the data representation of the first live audio signal and the second live audio signal into a live audio stream;
initiating, by the mobile computing device, a video capture; and
concurrent with the video capture, producing, by the mobile computing device, a shareable video based on the captured video and the live audio stream.

2. The computerized method of claim 1, wherein the wireless access point comprises a Wi-Fi access point.

3. The computerized method of claim 1, wherein the multi-channel audio interface pairs with the first musical instrument and the second musical instrument prior to receiving the first live audio signal from the first musical instrument and receiving the second live audio signal from the second musical instrument.

4. The computerized method of claim 3, wherein the wireless access point is configured to automatically detect the first musical instrument and the second musical instrument via the multi-channel audio interface.

5. The computerized method of claim 1, wherein the mobile computing device is further configured to upload the produced shareable video to a social network.

6. The computerized method of claim 1, wherein the video capture comprises ambient audio captured by one or more microphones of the mobile computing device.

7. The computerized method of claim 6, wherein the produced shareable video further comprises the ambient audio from the video capture.

8. The computerized method of claim 7, wherein an audio mix comprising the live audio stream and the ambient audio is configurable by a user of the mobile computing device.

9. The computerized method of claim 1, wherein the video capture comprises a first video feed from a rear-facing camera of the mobile computing device and a second video feed from a front-facing camera of the mobile computing device.

10. The computerized method of claim 9, wherein the produced shareable video comprises video from the first video feed and the second video feed.

11. The computerized method of claim 1, wherein the short-range communication protocol is Bluetooth.

12. A system for wireless capture of real-time multi-channel audio and video using a mobile computing device and a wireless access point, the system comprising:
a mobile computing device communicatively coupled to a wireless access point over a wireless network,
the wireless access point configured to:
detect a first musical instrument and a second musical instrument via a multi-channel audio interface, the first musical instrument and the second musical instrument wirelessly coupled to the multi-channel audio interface using a short-range communication protocol; and
receive a first live audio signal from the first musical instrument and a second live audio signal from the second musical instrument via the multi-channel audio interface;
the mobile computing device configured to:
receive a data representation of the first live audio signal and the second live audio signal via the wireless network;
process the data representation of the first live audio signal and the second live audio signal into a live audio stream;
initiate a video capture; and
concurrent with the video capture, produce a shareable video based on the captured video and the live audio stream.

13. The system of claim 12, wherein the wireless access point comprises a Wi-Fi access point.

14. The system of claim 12, wherein the multi-channel audio interface pairs with the first musical instrument and the second musical instrument prior to receiving the first live audio signal from the first musical instrument and receiving the second live audio signal from the second musical instrument.

15. The system of claim 14, wherein the wireless access point is configured to automatically detect the wireless access point is configured to automatically detect the first musical instrument and the second musical instrument via the multi-channel audio interface.

16. The system of claim 12, wherein the mobile computing device is further configured to upload the produced shareable video to a social network.

17. The system of claim 12, wherein the video capture comprises ambient audio captured by one or more microphones of the mobile computing device.

18. The system of claim 17, wherein the produced shareable video further comprises the ambient audio from the video capture.

19. The system of claim 18, wherein an audio mix comprising the live audio stream and the ambient audio is configurable by a user of the mobile computing device.

20. The system of claim 12, wherein the video capture comprises a first video feed from a rear-facing camera of the mobile computing device and a second video feed from a front-facing camera of the mobile computing device.

21. The system of claim 20, wherein the produced shareable video comprises video from the first video feed and the second video feed.

22. The system of claim 12, wherein the short-range communication protocol is Bluetooth.
